(19) United States
(12) Patent Application Publication
(10) Pub. No.: US 2026/0246158 A1
(43) Pub. Date: Aug. 20, 2026

(54) ANTENNA DEVICE

(71) Applicant: Panasonic Industry Co., Ltd., Osaka (JP)

(72) Inventors: Ryosuke HASABA, Kanagawa (JP); Tomoki ABE, Kanagawa (JP); Tomohiro MURATA, Kanagawa (JP); Koji TAKINAMI, Kanagawa (JP)

(73) Assignee: Panasonic Industry Co., Ltd., Osaka (JP)

(21) Appl. No.: 19/160,792

(22) PCT Filed: Mar. 1, 2024
(86) PCT No.: PCT/JP2024/007754

§ 371 Date: Aug. 28, 2025

(30) Foreign Application Priority Data
Mar. 3, 2023 (JP) 2023-032650

(51) Int. Cl. H01Q 19/10

(52) U.S. Cl. CPC H01Q 19/10

(57) ABSTRACT

This antenna device comprises: a radiator which includes a plurality of conductor portions stacked in mutually different layers in a stacked substrate and extending in a first direction, and a via extending in a second direction orthogonal to a plane along each of the plurality of conductor portions and connecting the plurality of conductor portions, the radiator radiating radio waves in a direction centered in a third direction orthogonal to the first direction and the second direction; a reflector provided in an opposite direction from the third direction and opposed to the radiator; and a feeding portion connected to a first conductor portion positioned at the center in the second direction among the plurality of conductor portions to feed power to the radiator.

### TECHNICAL FIELD

The present disclosure relates to an antenna apparatus.

### Background Art

It has been recently studied the formation of an antenna of a terminal for mobile communication using a high-frequency signal such as a millimeter wave or a sub-terahertz wave in a multilayer substrate.

For example, Non-Patent Literature (hereinafter, referred to as NPL) 1 describes an antenna structure in which a loop-shaped antenna with differential feeding is formed inside a multilayer substrate to radiate a radio wave in an endfire direction of a substrate.

For example, Patent Literature (hereinafter, referred to as PTL) 1 describes an antenna structure of an antenna array using a non-conductive via in a communication apparatus.

### CITATION LIST

### Patent Literature

PTL 1
Japanese Unexamined Patent Application Publication (Translation of PCT Application) No. 2019-536377

### Non-Patent Literature

NPL 1
J. Seo et al., “Miniaturized Dual-Band Broadside/Endfire Antenna-in-Package for 5G Smartphone,” in IEEE Transactions on Antennas and Propagation, vol. 69, no. 12, pp. 8100-8114, Dec. 2021

### SUMMARY OF INVENTION

However, there is room for study on miniaturization of the antenna in the multilayer substrate.

A non-limiting example of the present disclosure facilitates providing an antenna apparatus that can reduce the size of the antenna.

An antenna apparatus according to an exemplary embodiment of the present disclosure includes: a radiator that includes: a plurality of conductive layers laminated on layers different from one another inside a laminated substrate and extending in a first direction; and a via extending in a second direction orthogonal to a plane along each of the plurality of conductive layers and connecting the plurality of conductive layers, and radiates a radio wave in a third direction orthogonal to the first direction and the second direction; a reflector that is provided to face the radiator in a direction opposite to the third direction; and a feeder that is connected to a first conductive layer located at a center in the second direction among the plurality of conductive layers, and feeds the radiator.

According to an exemplary embodiment of the present disclosure, an antenna can be miniaturized.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of communication between a terminal and an access point;

FIG. 2 illustrates exemplary antennas mounted in a terminal;

FIG. 3 illustrates an example of a substrate including antennas;

FIG. 4 illustrates an example of a differential line;

FIG. 5 is a perspective view of an exemplary antenna apparatus according to an embodiment of the present disclosure;

FIG. 6 is a side view of the exemplary antenna apparatus according to the embodiment of the present disclosure as viewed from the positive direction of a Y axis;

FIG. 7 is a view of an exemplary radiator of the antenna apparatus according to the embodiment of the present disclosure as viewed from the positive direction of an X axis;

FIG. 8 is a view of the exemplary antenna apparatus according to the embodiment of the present disclosure as viewed from the positive direction of a Z axis;

FIG. 9 illustrates an example of input impedance of the radiator in a case where the length of a dielectric is changed;

FIG. 10A is a perspective view of the antenna apparatus for describing an example of impedance adjustment according to the embodiment of the present disclosure;

FIG. 10B is a view of the exemplary radiator of the antenna apparatus illustrated in FIG. 10A as viewed from the positive direction of the X axis;

FIG. 10C is a view of the exemplary radiator of the antenna apparatus illustrated in FIG. 10A as viewed from the positive direction of the Z axis;

FIG. 11 illustrates an example of a change in impedance accompanied by a shift of a feeding position;

FIG. 12A is a view of a first comparative example in which single-ended feeding is employed as viewed from the positive direction of the Z axis;

FIG. 12B is a view of the radiator illustrated in FIG. 12A as viewed from the positive direction of the X axis;

FIG. 13 illustrates examples of directivity of the antenna apparatus according to the embodiment of the present disclosure and the first comparative example;

FIG. 14 is a perspective view of an example of an antenna apparatus corresponding to a second comparative example of the antenna apparatus according to the embodiment of the present disclosure; and

FIG. 15 is a view of exemplary frequency responses of reflection characteristics of the antenna apparatus according to the embodiment of the present disclosure and the second comparative example.

### DESCRIPTION OF EMBODIMENTS

Hereinafter, an embodiment of the present disclosure will be described in detail with appropriate reference to the drawings. However, a detailed description more than necessary may be omitted. For example, detailed descriptions of well-known matters and redundant descriptions of substantially the same configuration may be omitted. This is to avoid the unnecessary redundancy of the following description and to facilitate understanding of those skilled in the art.

Note that, the accompanying drawings and the following description are provided so that those skilled in the art understand the present embodiment sufficiently, and are not intended to limit the subject matters recited in the claims.

In the various drawings, for the sake of clarity, some elements are omitted, and some elements may not be drawn to scale.

### Knowledge Leading to Present Disclosure

Mobile communication using a high-frequency signal such as a millimeter wave or a sub-terahertz wave has been recently studied.

In the millimeter wave or the sub-terahertz wave bands, the wavelength of the radio wave is a few millimeters or less, resulting in significant distance-related attenuation. In a case where a terminal such as a smartphone includes an antenna having directivity inside thereof, there is a possibility that the direction of a main beam is not uniformly determined.

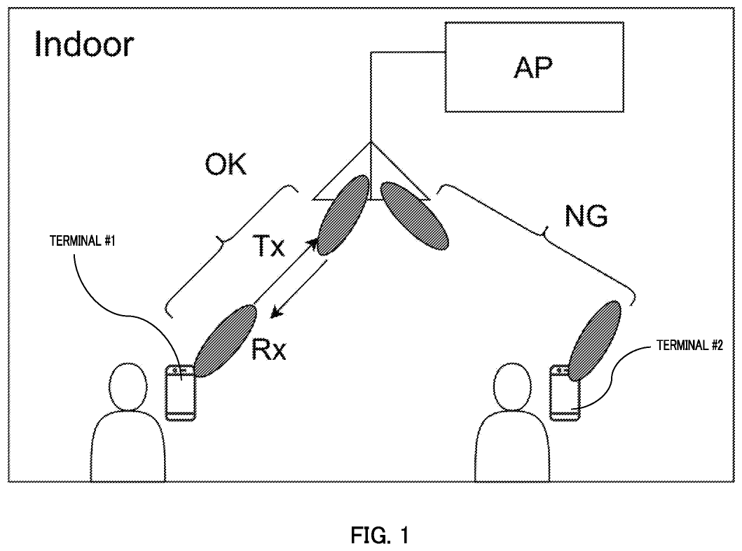

FIG. 1 illustrates an example of communication between a terminal and an access point. FIG. 1 illustrates an example in which, in an indoor environment, terminal #1, terminal #2, and an access point (AP) each form a beam by directivity control, and transmit or receive a signal using the formed beam.

As illustrated in FIG. 1, the beam formed by terminal #1 faces the beam formed by the access point, and thus communication between terminal #1 and the access point is appropriately performed. The beam formed by terminal #2 faces a direction different from the beam formed by the access point, and the beams do not face each other. In the case of terminal #2, the communication may become difficult. Therefore, it is desired that the antenna mounted in the terminal cover various directions.

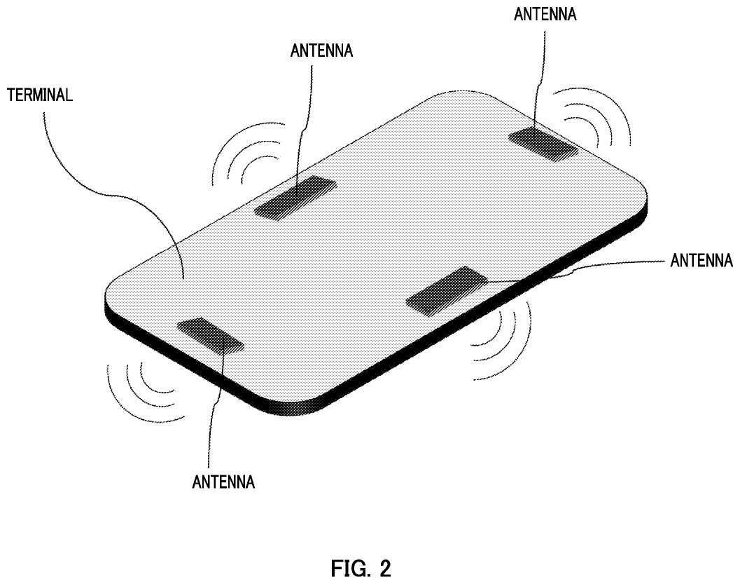

FIG. 2 illustrates exemplary antennas mounted in a terminal. As illustrated in FIG. 2, a plurality of antennas (four antennas in the example of FIG. 2) is mounted inside the terminal, and it is desired to cover various three-dimensional directions using the plurality of antennas. The plurality of antennas each include an antenna that forms a beam in an endfire direction and radiates a radio wave.

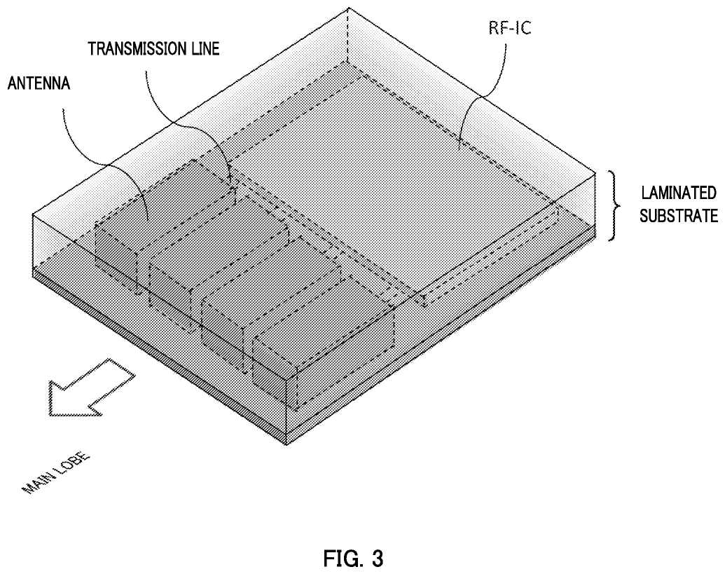

FIG. 3 illustrates an example of a substrate including an antenna. The antenna of a terminal is included in a multilayer substrate together with a circuit configuration other than the antenna. In the example of FIG. 3, the antenna is included in the laminated substrate together with a radio frequency-integrated circuit (RF-IC). The antenna in FIG. 3 transmits a signal input from the RF-IC via a transmission line or outputs a received signal to the RF-IC via the transmission line. The antenna in FIG. 3 radiates a radio wave in a horizontal direction with respect to the laminated substrate (e.g., direction along a substrate of the laminated substrate).

In order to reduce the size of the terminal, it is desired to reduce the size of the antenna formed in the multilayer substrate. In addition, a dipole-type element is used as the element of the antenna that radiates a radio wave in the horizontal direction of the multilayer substrate corresponding to the endfire direction.

As an example of an antenna structure formed in a multilayer substrate, NPL 1 describes an antenna structure that includes a loop-shaped antenna and a ground plane inside the multilayer substrate. The loop-shaped antenna includes copper foil and a via and is fed through a differential line. The ground plane is provided on the rear surface of the antenna. In the antenna structure of NPL 1, a radio wave is radiated in the endfire direction of the substrate.

Furthermore, as an example of the antenna structure formed in the multilayer substrate, PTL 1 describes an antenna structure of an antenna array that includes a patch-shaped antenna formed of a via and copper foil inside a multilayer substrate and that provides a sparse region near the antenna.

However, in the antenna structure of NPL 1, the feed line is implemented as a differential line, thereby increasing the size of the antenna structure.

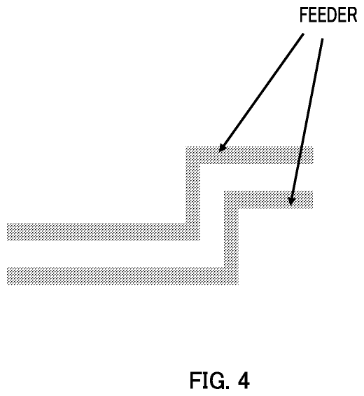

FIG. 4 illustrates an example of the differential line. As illustrated in FIG. 4, the differential line is disposed with a space between the two lines, and thus the area of wiring is increased by the width between the two lines, resulting in an increase in the size of the antenna structure. In addition, the differential line connects the antenna and a signal supply source, and thus, in a case where the antenna and the signal supply source (e.g., RF-IC in FIG. 3) are not present in a straight line, the differential line is bent in the middle as illustrated in FIG. 4. At a place where the differential line is bent, the area of wiring is increased, which increases the size of the antenna structure.

Furthermore, in the antenna structure of NPL 1, a feed point to the antenna is limited to a loop end of the loop-shaped antenna, which makes it difficult to adjust impedance. Moreover, in a case where the feed line is switched from differential to single-ended, the feed line itself radiates, the directivity of the radiation of the antenna does not face a desired direction, the beam pattern collapses, and the electrical characteristics deteriorate.

In addition, in the antenna structure of PTL 1, since a probe is used for feeding and the vias are densely disposed, the size of the antenna structure is increased.

Then, in the following embodiment, an antenna apparatus that can reduce the size of the antenna in the multilayer substrate will be described. In addition, in the following embodiment, it will be described that the antenna apparatus can reduce the size of the antenna and can improve the electrical characteristics of the antenna.

### Embodiment

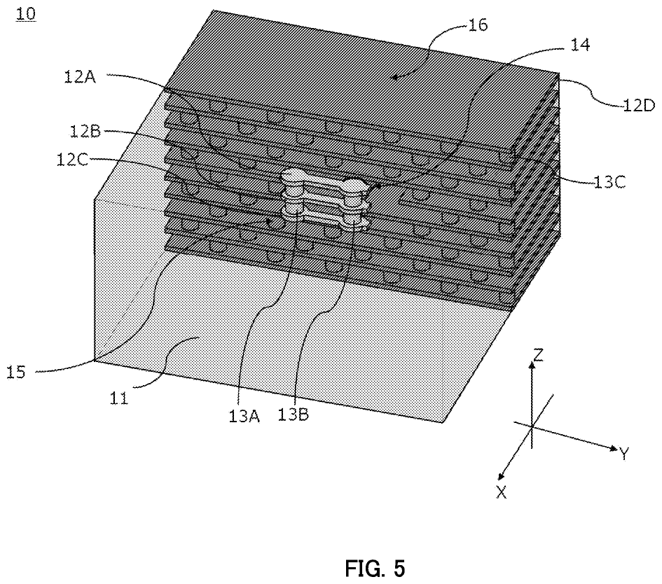

FIG. 5 is a perspective view of an example of antenna apparatus 10 according to the present embodiment. In FIG. 5, antenna apparatus 10 is illustrated, and an X axis, a Y axis, and a Z axis defined with respect to antenna apparatus 10 are shown. Furthermore, FIG. 5 illustrates antenna apparatus 10 in a state in which a part of dielectric 11 is transparent. Dielectric 11 may be composed of a plurality of layers (a plurality of dielectric layers).

Antenna apparatus 10 is formed inside a laminated substrate. Antenna apparatus 10 includes radiator 15, reflector 16, and feeder 14. Radiator 15 and reflector 16 may be provided substantially in parallel to each other.

The laminated substrate has a configuration in which dielectric 11 and copper foil are laminated. A plane along the surface on which the copper foil is provided is defined as an X-Y plane. The X-Y plane is a plane defined by the X axis and the Y axis. In this case, a layer of the dielectric and a layer of the copper foil are provided along the X-Y plane.

The Z axis is an axis orthogonal to the X axis and the Y axis and extending along the thickness direction of the laminated substrate. The thickness direction may also be referred to as a height direction or a lamination direction. In addition, in the following description, the positive direction of the Z axis corresponds to “up” or an “upper direction,” and the negative direction of the Z axis corresponds to “down” or a “lower direction.”

The X axis indicates an axis extending along a direction in which radiator 15 of antenna apparatus 10 is provided. In this case, the X axis indicates an axis extending along the direction of a main beam of a radio wave radiated from antenna apparatus 10. For example, antenna apparatus 10 radiates a radio wave in a direction centered around the positive direction of the X axis. Note that the negative direction of the X axis corresponds to a “depth direction.”

The Y axis indicates an axis orthogonal to the X axis and the Z axis. In the following description, the Y axis corresponds to a “lateral direction,” the positive direction of the Y axis corresponds to “right” or a “right direction,” and the negative direction of the Y axis corresponds to “left” or a “left direction.”

Furthermore, in the following, a plane defined by the X axis and the Z axis may be referred to as an X-Z plane, and a plane defined by the Y axis and the Z axis may be referred to as a Y-Z plane.

Although not illustrated in FIG. 5, a configuration other than the configuration illustrated in FIG. 5 may be included in the laminated substrate. For example, as in the example of FIG. 3, the laminated substrate may include an RF-IC.

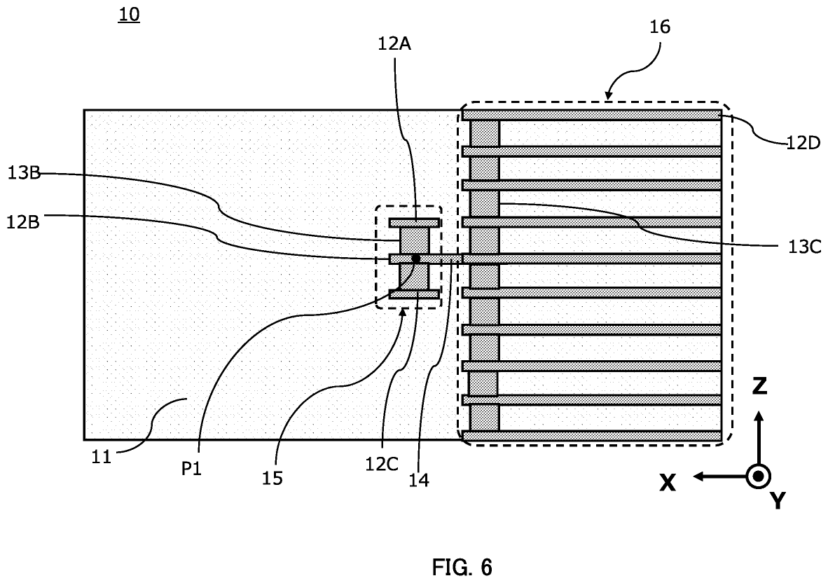

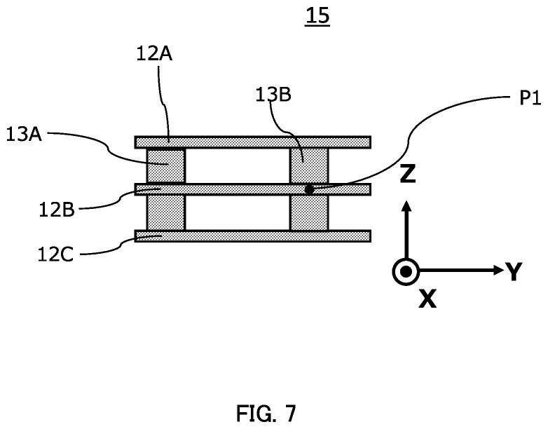

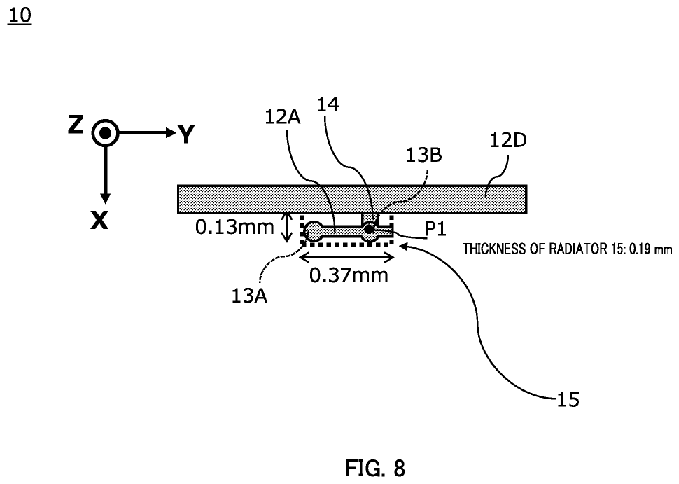

FIG. 6 is a side view of an example of antenna apparatus 10 according to the present embodiment as viewed from the positive direction of the Y axis. FIG. 7 is a view of an example of radiator 15 of antenna apparatus 10 according to the present embodiment as viewed from the positive direction of the X axis. FIG. 8 is a view of a part of antenna apparatus 10 according to the present embodiment as viewed from the positive direction of the Z axis. Hereinafter, antenna apparatus 10 will be described with reference to FIGS. 5 to 8.

Radiator 15 is provided on a side surface of reflector 16 along the Y-Z plane. Radiator 15 includes copper foil 12A, copper foil 12B, copper foil 12C, via 13A, and via 13B.

Copper foils 12A to 12C are laminated on different layers. Copper foils 12A to 12C each have a shape extending in the Y-axis direction. In a case where the effective wavelength of a radio wave radiated by radiator 15 is represented by λ, the length of each of copper foils 12A to 12C along the Y-axis direction may be from λ/4 to λ/2. The effective wavelength is determined based on, for example, the wavelength of the radio wave radiated by radiator 15 in vacuum and the permittivity of dielectric 11.

Note that, in the present embodiment, the copper foil is exemplified as an example of a conductive portion (a plurality of conductive layers) forming radiator 15, but the conductive portion is not limited to the copper foil and may be foil (or a layer) formed of another metal or conductor.

Via 13A and via 13B each extend in a direction along the Z-axis direction. Via 13A is provided on a left side (negative direction of the Y axis) relative to via 13B, and penetrates copper foil 12B to connect copper foil 12A and copper foil 12C. Via 13B is provided on a right side (side of positive direction of the Y axis) relative to via 13A, and penetrates copper foil 12B to connect copper foil 12A and copper foil 12C. In this manner, radiator 15 is configured in a closed loop shape by copper foil 12A, copper foil 12C, via 13A, and via 13B.

Reflector 16 includes a plurality of copper foils 12D laminated in the lamination direction and via 13C that connects the plurality of copper foils 12D. Reflector 16 may be a ground conductor. Reflector 16 is formed in a wall shape in the lamination direction.

Reflector 16 illustrated in FIGS. 5 to 8 is constituted by the plurality of copper foils and the via, but the present disclosure is not limited thereto. For example, reflector 16 may be constituted by the plurality of copper foils without including the via. Since the reflector is constituted by the plurality of copper foils without including the via, the via is not necessary, and the reflector can be easily manufactured. Alternatively, reflector 16 may be formed of a metal housing. The reflector is formed of a metal housing, and thus the reflector can be shaped as a plate, thereby improving antenna characteristics.

Feeder 14 is a single line and feeds radiator 15 in a single-ended manner. Feeder 14 is connected to copper foil 12B included in radiator 15 and feeds radiator 15. In the present embodiment, feeder 14 is exemplarily connected to position P1 where copper foil 12B and via 13B are connected. Position P1 where feeder 14 is connected to radiator 15 may be referred to as a feeding position. Copper foil 12B is positioned at the center in the lamination direction among copper foils 12A, 12B, and 12C.

In the present embodiment, the feeding position is provided at copper foil 12B that is present at a position dividing radiator 15 into two parts, and feeding power from the feeding position via feeder 14 allows for feeding to the loop-shaped antenna in a manner similar to the case of feeding via a differential line.

The feeding position may be determined based on a position where copper foil 12A and via 13A are connected and the wavelength of the radio wave radiated by radiator 15. For example, the length along the conductive portion between the feeding position and the position where copper foil 12A and via 13A are connected may be substantially ½ of the effective wavelength of the radio wave determined based on the permittivity of dielectric 11.

Note that the impedance of radiator 15 can be adjusted by adjusting the position of the feeding position in the Y-axis direction.

According to the configuration of antenna apparatus 10, radiator 15 can be constituted by via 13A, via 13B, copper foil 12A, copper foil 12B, and copper foil 12C, thereby reducing the size of the antenna.

FIG. 8 illustrates an exemplary size of antenna apparatus 10 according to the present embodiment. FIG. 8 illustrates the size of radiator 15 of antenna apparatus 10 in a case where a radio wave having a center frequency of 160 GHz is radiated. For example, the size of radiator 15 is 0.13 mm in the depth direction, 0.37 mm in the lateral direction, and 0.19 mm in the thickness direction. In a case where this size is converted into dimensions of an antenna of 40 GHz, the size (e.g., size of radiator 15) of antenna apparatus 10 obtained by multiplying respective lengths in three dimensions is 1.48 mm×0.52 mm×0.76 mm=0.58. Meanwhile, the size of the antenna structure described in NPL 1 is 2.0 mm×0.8 mm×0.76 mm=1.2. As described above, the size of antenna apparatus 10 according to the present embodiment can be reduced by approximately 50% compared to the size of the antenna structure described in NPL 1.

In addition, according to the configuration of antenna apparatus 10, the impedance of antenna apparatus 10 can be flexibly adjusted by adjusting the feeding position where feeder 14 feeds.

Next, an example of the impedance of antenna apparatus 10 will be described.

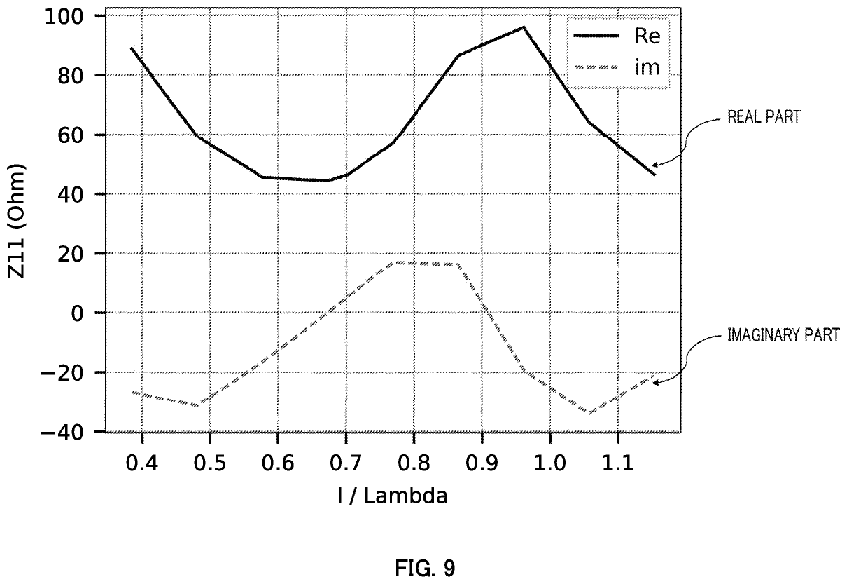

FIG. 9 illustrates an example of the input impedance of antenna apparatus 10 according to the present embodiment in a case where the length of the dielectric is changed. A horizontal axis in FIG. 9 indicates a length in a direction in which radiator 15 of the dielectric is provided (the positive direction of the X axis). Note that, in the horizontal axis in FIG. 9, the length in the radiation direction of the dielectric (the positive direction of the X axis) is normalized with respect to the wavelength λ. Exemplarily, in the example of FIG. 9, λ is a wavelength corresponding to a frequency of 157 GHz. A vertical axis in FIG. 9 indicates a value of impedance. A solid line in FIG. 9 indicates the real part of the impedance, and a broken line indicates the imaginary part of the impedance.

As illustrated in FIG. 9, the impedance changes when the size of the dielectric (e.g., the length in the positive direction of the X axis) changes. Thus, it is desirable that the impedance of the antenna can be easily adjusted.

In antenna apparatus 10 according to the present embodiment, the impedance of the antenna can be adjusted by adjusting the feeding position. In the following, an example of impedance adjustment by the adjustment of the feeding position will be described.

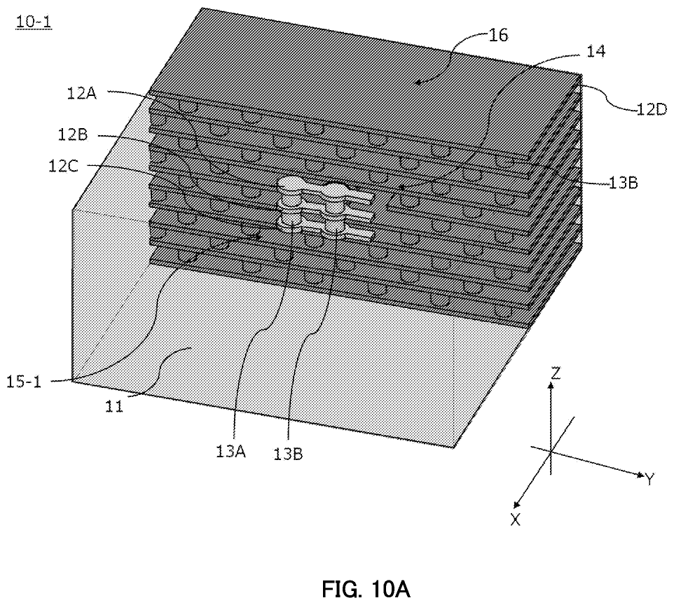

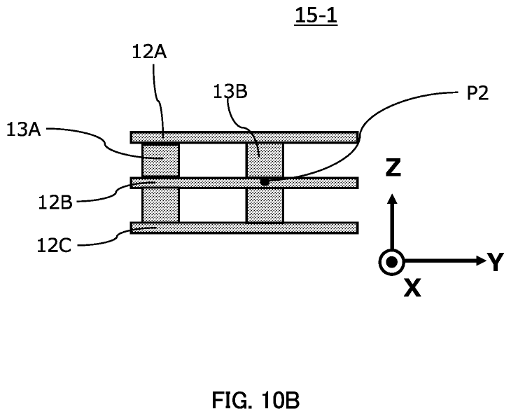

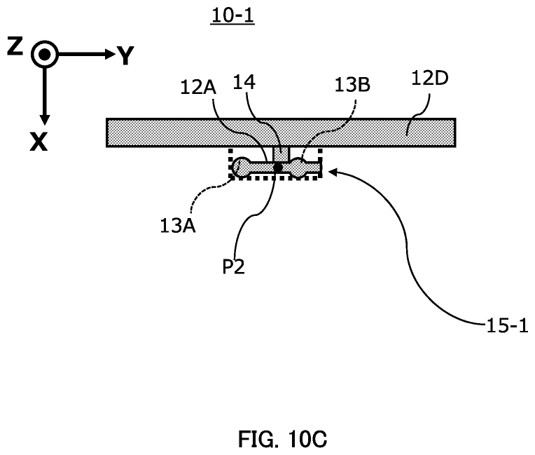

FIG. 10A is a perspective view of antenna apparatus 10-1 for describing an example of impedance adjustment according to the present embodiment. FIG. 10B is a view of an example of radiator 15-1 of antenna apparatus 10-1 illustrated in FIG. 10A as viewed from the positive direction of the X axis. FIG. 10C is a view of an example of radiator 15-1 of antenna apparatus 10-1 illustrated in FIG. 10A as viewed from the positive direction of the Z axis.

In antenna apparatus 10-1 illustrated in FIGS. 10A, 10B, and 10C, feeding position P2 of radiator 15-1 is moved in the left direction (negative direction of the Y axis) relative to feeding position P1 of radiator 15 of antenna apparatus 10 illustrated in FIGS. 5 to 8. Furthermore, a distance between via 13A and via 13B in the Y-axis direction is changed in association with this movement. Hereinafter, the amount of movement of the feeding position is referred to as a shift amount.

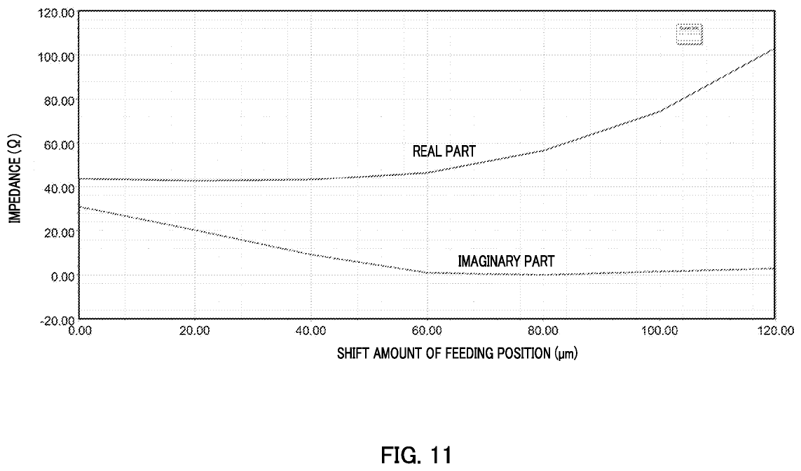

FIG. 11 illustrates an example of a change in impedance in association with the shift of the feeding position. A horizontal axis in FIG. 11 indicates the shift amount of the feeding position, and a vertical axis indicates a value of impedance. The unit of the shift amount on the horizontal axis is [μm]. The case where the horizontal-axis value is zero corresponds to a case where the feeding position is present at a right end portion of copper foil 12B, and the shift amount indicated by the horizontal axis indicates a length shifted from the end portion of copper foil 12B in the left direction (negative direction of the Y axis). A solid line in FIG. 11 indicates the real part of the impedance, and a broken line indicates the imaginary part of the impedance.

As illustrated in FIG. 11, even in a case where antenna apparatus 10 is present inside the dielectric of the multilayer substrate, the impedance can be easily adjusted by changing the feeding position.

For example, easily adjusting the impedance makes it possible to easily match the input impedance of antenna apparatus 10 and the impedance of a circuit configuration that supplies a signal to antenna apparatus 10.

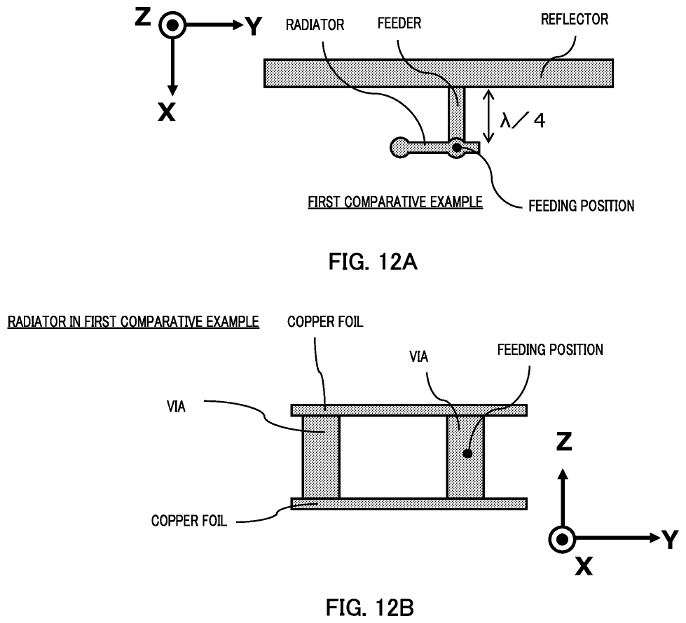

FIG. 12A is a view of a first comparative example in which power is fed in a single-ended manner, as viewed from the positive direction of the Z axis. FIG. 12B is a view of a radiator illustrated in FIG. 12A as viewed from the positive direction of the X axis. The first comparative example illustrated in FIGS. 12A and 12B is an example in which copper foil 12B is omitted in radiator 15 of antenna apparatus 10 and a distance between the radiator and the reflector is longer than that of antenna apparatus 10.

As illustrated in FIG. 8, antenna apparatus 10 according to the present embodiment has a small distance between the radiator and the reflector in the direction along the X axis as compared with FIG. 12A. For example, in the first comparative example illustrated in FIG. 12A, the distance between the radiator and the reflector is approximately λ/4. On the other hand, the distance between radiator 15 and reflector 16 of antenna apparatus 10 may be approximately λ/10. Note that λ here may be an effective wavelength of the radiated radio wave. In the present embodiment, reducing the distance between radiator 15 and reflector 16 in the direction along the X axis is referred to as height reduction of antenna apparatus 10. In this case, FIG. 8 illustrates antenna apparatus 10 having a reduced height as compared with FIG. 12A.

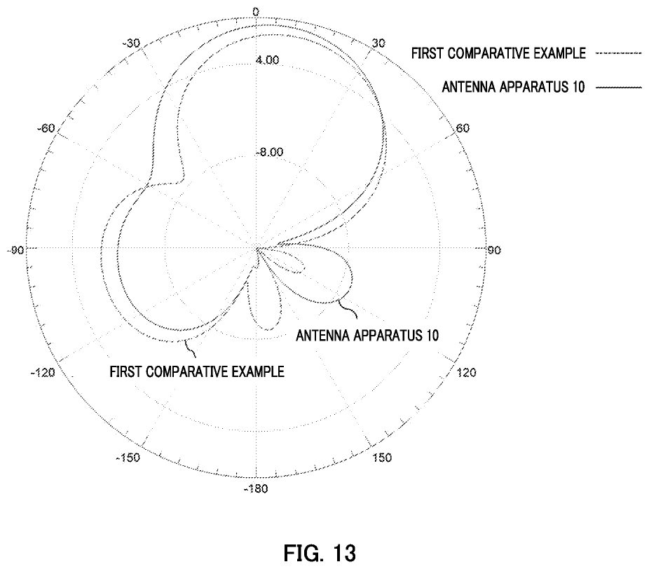

FIG. 13 illustrates examples of directivity of antenna apparatus 10 according to the embodiment of the present disclosure and the first comparative example. FIG. 13 illustrates the directivity of each of antenna apparatus 10 and the first comparative example in the X-Y plane. Note that, in FIG. 13, the directivity of antenna apparatus 10 is indicated by a solid line, and the directivity of the first comparative example is indicated by a broken line. In addition, in FIG. 13, a direction of zero degrees is a direction along the positive direction of the X axis.

As the directivity of antenna apparatus 10 in FIG. 13 shows, by reducing the height of antenna apparatus 10, the directivity of the antenna can be more strongly directed in the front direction (the positive direction of the X axis), and the radio wave can be more strongly radiated in the front direction.

In addition, as illustrated in FIGS. 12A and 12B, in a case where the power is fed in a single-ended manner to the loop-shaped radiator in which the copper foil is not present in the middle, the distance between the radiator and the reflector is required to be widened to approximately λ/4, but in antenna apparatus 10 according to the present embodiment, the power can be fed at copper foil 12B present at the center of radiator 15 in the lamination direction, thereby enabling reduction of the height. Reduction of the height can reduce the size (e.g., volume) of antenna apparatus 10.

FIGS. 5 to 8 illustrates antenna apparatus 10 in which radiator 15 is relatively sparse. The differences in the density of the conductors will be described.

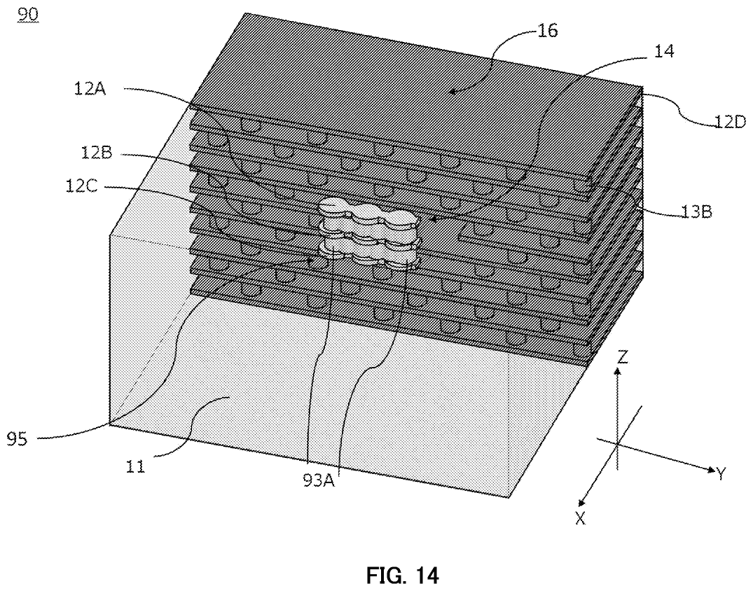

FIG. 14 is a perspective view of an example of antenna apparatus 90 corresponding to a second comparative example of antenna apparatus 10 according to the present embodiment. In FIG. 14, the same components as those in FIGS. 5 to 8 are denoted by the same reference numerals, and the description thereof may be omitted.

Antenna apparatus 90 illustrated in FIG. 14 has a configuration in which radiator 15 of antenna apparatus 10 illustrated in FIGS. 5 to 8 is replaced with radiator 95. Radiator 95 has a structure in which the conductors of radiator 95 are provided more densely than those of radiator 15 of antenna apparatus 10 illustrated in FIGS. 5 to 8.

For example, in radiator 95 of antenna apparatus 90 illustrated in FIG. 14, vias 93A between copper foils 12A, 12B, and 12C are densely provided as compared with vias 13A and 13B of radiator 15 of antenna apparatus 10 illustrated in FIGS. 5 to 8.

Electrical characteristics of antenna apparatus 10 according to the present embodiment illustrated in FIGS. 5 to 8 and antenna apparatus 90 which is the second comparative example illustrated in FIG. 14 are compared.

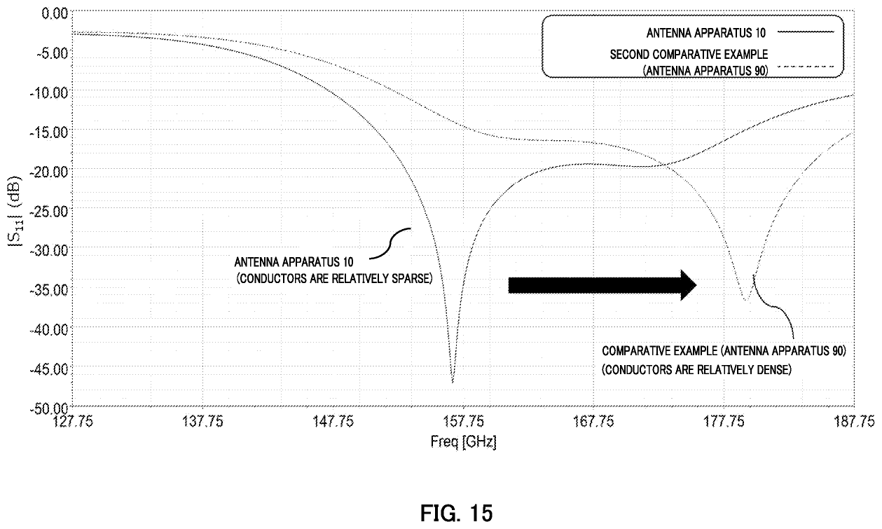

FIG. 15 illustrates exemplary frequency responses of reflection characteristics of antenna apparatus 10 according to the present embodiment and the second comparative example. A horizontal axis in FIG. 15 indicates a frequency, and a vertical axis in FIG. 15 indicates a value of S11, which is an S parameter indicating the reflection characteristic.

As illustrated in FIG. 15, the reflection characteristic of antenna apparatus 10 indicates a minimum value around 157 GHz. This reflection characteristic indicates that the resonance frequency of antenna apparatus 10 is 157 GHz. On the other hand, the reflection characteristic of antenna apparatus 90 indicates a minimum value around 180 GHz. This reflection characteristic indicates that the resonance frequency of antenna apparatus 90 is 180 GHZ.

As described above, although the sizes of the antenna apparatuses (e.g., radiators) are the same, the resonance frequency shifts toward a high frequency region as the conductors become denser, as seen in antenna apparatus 90. For example, in a case where antenna apparatuses that resonate with each other at the same frequency are configured, the configuration in which the conductors are relatively sparse as in antenna apparatus 10 makes it possible to configure the antenna apparatus having a small size compared with the configuration in which the conductors are relatively dense as in antenna apparatus 90.

As described above, antenna apparatus 10 according to the present embodiment includes radiator 15, reflector 16, and feeder 14 (example of feeding portion). Radiator 15 includes: a plurality of copper foils (example of a plurality of conductive layers) that are laminated on different layers from one another inside the laminated substrate and extend in the Y-axis direction; and a via that extends in the Z-axis direction orthogonal to the X-Y plane along each of the surfaces of the plurality of copper foils and connects the plurality of copper foils, and radiator 15 radiates a radio wave in a direction centered around the positive direction of the X axis orthogonal to the Y-axis direction and the Z-axis direction. Reflector 16 is provided to face radiator 15 in a direction opposite to the positive direction of the X axis. Feeder 14 is connected to the copper foil positioned at the center in the Z-axis direction among the plurality of copper foils, and feeds radiator 15. According to this configuration, radiator 15 can be constituted by via 13A and copper foils 12A, 12B, and 12C, thereby reducing the size of the antenna.

Note that, in the present embodiment, an example has been described in which radiator 15 includes three layers of copper foil, but the present disclosure is not limited thereto. For example, the radiator may include four or more layers of copper foil. In this case, the feeding position may be provided in the copper foil at the center in the lamination direction among the plurality of copper foils. For example, the feeding position of the radiator having five layers of copper foil may be provided in the third layer of the copper foil from the top. For example, the antenna apparatus may be configured to radiate a radio wave having a desired polarization characteristic by adjusting the feeding position. For example, the antenna apparatus may be configured to radiate a horizontally polarized wave by providing the feeding position in the copper foil at the center in the lamination direction among the plurality of copper foils. Alternatively, the antenna apparatus may be configured to radiate a circularly polarized wave by providing the feeding position in the copper foil at a position different from the center in the lamination direction among the plurality of copper foils.

Note that, in the present embodiment, an example has been described in which radiator 15 includes two vias, but the present disclosure is not limited thereto. Three or more vias may connect the plurality of copper foils.

Note that, in the present embodiment, the term “radio wave” may be replaced with an expression such as “electromagnetic wave,” “signal,” or “beam.” Furthermore, in the present embodiment, an example has been described in which the antenna apparatus is a transmission apparatus that radiates a radio wave, but the antenna apparatus in the present embodiment may be applied to a reception apparatus that receives a radio wave.

### Summary of Embodiment

An antenna apparatus according to an embodiment of the present disclosure includes: a radiator that includes: a plurality of conductive layers laminated on layers different from one another inside a laminated substrate and extending in a first direction; and a via extending in a second direction orthogonal to a plane along each of the plurality of conductive layers and connecting the plurality of conductive layers, and radiates a radio wave in a third direction orthogonal to the first direction and the second direction; a reflector that is provided to face the radiator in a direction opposite to the third direction; and a feeder that is connected to a first conductive layer located at a center in the second direction among the plurality of conductive layers, and feeds the radiator.

In the present antenna apparatus, the feeder is connected to the first conductive layer at a position corresponding to impedance of the antenna apparatus.

In the present antenna apparatus, the reflector is formed of a conductive layer of the laminated substrate.

In the present antenna apparatus, the reflector is formed of a metal housing.

In the present antenna apparatus, a first position of the first conductive layer to which the feeder is connected is determined based on a second position at which a second conductive layer located at an outermost end in the second direction among the plurality of conductive layers and the via are connected and based on a wavelength of the radio wave.

In the present antenna apparatus, a length between the first position and the second position along a conductor is substantially ½ of an effective wavelength of the radio wave based on permittivity inside a dielectric of the laminated substrate.

Although the embodiments have been described above with reference to the drawings, the present disclosure is not limited to these examples. Obviously, a person skilled in the art would arrive variations and modifications within a scope described in claims. It is understood that these variations and modifications are within the technical scope of the present disclosure. In addition, the components in the embodiments may be optionally combined without departure from the spirit of the present disclosure.

The disclosure of Japanese Patent Application No. 2023-032650, filed on Mar. 3, 2023, including the specification, drawings and abstract, is incorporated herein by reference in its entirety.

### INDUSTRIAL APPLICABILITY

An exemplary embodiment of the present disclosure is useful for an antenna apparatus.

### REFERENCE SIGNS LIST

10, 90 Antenna apparatus
12A, 12B, 12C, 12D Copper foil (Conductive layer)
13A, 13B, 13C, 93A Via
14 Feeder
15, 95 Radiator
16 Reflector

1. An antenna apparatus, comprising:
a radiator that includes: a plurality of conductive layers laminated on layers different from one another inside a laminated substrate and extending in a first direction; and a via extending in a second direction orthogonal to a plane along each of the plurality of conductive layers and connecting the plurality of conductive layers, and radiates a radio wave in a third direction orthogonal to the first direction and the second direction;
a reflector that is provided to face the radiator in a direction opposite to the third direction; and
a feeder that is connected to a first conductive layer located at a center in the second direction among the plurality of conductive layers, and feeds the radiator.

2. The antenna apparatus according to claim 1, wherein
the feeder is connected to the first conductive layer at a position corresponding to impedance of the antenna apparatus.

3. The antenna apparatus according to claim 1, wherein
the reflector is formed of a conductive layer of the laminated substrate.

4. The antenna apparatus according to claim 1, wherein
the reflector is formed of a metal housing.

5. The antenna apparatus according to claim 1, wherein
a first position of the first conductive layer to which the feeder is connected is determined based on a second position at which a second conductive layer located at an outermost end in the second direction among the plurality of conductive layers and the via are connected and based on a wavelength of the radio wave.

6. The antenna apparatus according to claim 5, wherein
a length between the first position and the second position along a conductor is substantially ½ of an effective wavelength of the radio wave based on permittivity inside a dielectric of the laminated substrate.
